(19) United States
(12) Patent Application Publication
(10) Pub. No.: US 2016/0283675 A1
(43) Pub. Date: Sep. 29, 2016

(54) Quality Assurance Injection Method and System

(71) Applicant: Vericle Corporation, Clearwater, FL (US)

(72) Inventors: Yuval Lirov, Clearwater Beach, FL (US); Erez Lirov, Morganville, NJ (US)

(21) Appl. No.: 14/665,502

(22) Filed: Mar. 23, 2015

(51) Int. Cl. G06F 19/00

(52) U.S. Cl. CPC G06F 19/328

(57) ABSTRACT

A quality assurance injection method and system. A method and system whereby tagged claims are intentionally injected into a billing system so that quality assurance can be tested. Using a known number of false claims along with a known number of true claims, an administrator can quantitatively assess the efficacy of quality assurance staff. The method and system can be used with pre-programmed computer systems that have rules-based procedures to increase the accuracy and efficiency of the overall system.

### BACKGROUND OF THE INVENTION

1. Field of the Invention

This invention relates to insurance billing. More specifically, this invention relates to a method for improving the overall quality assurance of an insurance billing claims system.

2. Description of the Background Art

Billing for insurance is a long and complicated process. Mistakes can be made. For example, every day, millions of people go to doctors and hospitals seeking care; some have insurance, some do not. And when these people leave medical care, there is a claim which needs to be paid, generally by the insurance carrier. Each patient has unique information associated with their visit. Each patient also has an individual policy with their insurance carrier, if they even have insurance.

Most medical practices take care of these claims through their accounts receivable office. In doctor's offices and hospitals, where hundreds of patients are handled every day, the accounts receivable office is of paramount importance.

Medical claims are generally made up of three parts: (1) the patient's demographic information (name, age, sex, etc.); (2) the patient's insurance information including the type of plan they have; and (3) the diagnostic and procedure information. The diagnostic and procedure information contains validation information that tells whoever is looking at the claim what was/needs to be performed. Various codes are associated with various procedures and diagnoses. For example, a procedure to amputate a patient's left foot would have a different validation code than amputation of a patient's right hand. A bad medical claim will either be missing one of these parts (demographic, insurance information, or diagnostic/procedure code) or the insurance company will deny the claim because some part of the patient's policy, which was not included in the system, means that they were not covered for the particular procedure. Bad claims are considered bad because they are generally not paid upon first submission.

Most of these offices have staff performing these billing processes by hand or through a computer system with out of date rules, which can lead to mistakes. It is important to know how often mistakes occur in order to determine the best method to prevent those mistakes.

There presently exists rules-based methods for determining how to process insurance claim and account data. For example, US 2003/0191667 A1 to Fitzgerald et al. discloses a system whereby a central rules repository contains rules for processing claims. Each rule can contain a list of actions to be performed for a true result and another list of action to be performed for a false result. These actions include the creation of worklists, creation of logs or audit reports, creation of error reports, generation of claims, posting of remittances, modification of data, and other actions. However, what is lacking from Fitzgerald is a way for these rules and actions to evolve based on the intentional introduction of tagged claims in order to assess quality assurance staff. Fitzgerald also lacks any description of a method or system that more accurately determines the number of bad claims in a billing system.

Therefore, it is an object of this invention to provide an improvement which overcomes the aforementioned inadequacies of prior methods and provides an improvement which is a significant contribution to the advancement of quality assurance art.

Another object of this invention is to provide a method for intentionally injecting false claims into an accounts receivable system and determining the number of false claims that were caught by the quality assurance staff.

A further object of this invention is to improve quality assurance for insurance billing.

Yet another object of this invention is to provide a method to determine the best quality assurance staff team out of multiple teams.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a quality assurance method for an accounts receivable system whereby a known number of true insurance claims are entered into a computer-implemented system and a known number of tagged claims are entered into the same computer-implemented system. A sample group of the true insurance claims and tagged claims are sent to quality assurance staff, who examine the sample group for bad claims. The system can be configured to keep track of the number of bad claims caught by staff over a set amount of time. The accuracy and efficiency of the quality assurance staff can be tracked and different teams of quality assurance staff can be assessed using the disclosed invention. Overall, the system improves through the identification of common issues in bad claims by quality assurance staff and by having a more accurate estimate of the total number of bad claims within the insurance billing system.

The disclosed method and system has several important advantages. For example, the disclosed method and system allows for the computer system to learn what makes up a deceptively bad claim and what makes a clearly bad claim for future processing. Also, the disclosed method and system allows administrators to actively assess their staff and determine where mistakes are being made.

The disclosed method and system also allows for the improved precision of an error rate estimate, thereby reducing the sample size necessary for quality assurance staff to analyze. This, in turn, reduces costs.

The disclosed method and system also improves quality assurance through the use of built-in checks and balances. If the quality assurance staff finds fewer bad claims than were injected into the system (which could include actual true claims that should be invalid or rejected), or they discover none at all, then some combination of issues within the system is not working. These issues can include the randomization of generation of false claims or randomization of samples sent to quality assurance staff, the injection of these false claims into the systems, or the quality assurance team itself. The disclosed method and system allows for administrators to determine the issues and efficiently solve them.

The disclosed method and system should not be construed to be limited to only the medical insurance industry. The present disclosure has wide ranging application that will help increase the accuracy and efficiency of insurance billing in general.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a flow chart depicting a computer-implemented method and system of the present disclosure.

FIG. 2 is a block diagram providing a visualization of the relative amount of bad claims against total claims and quality assurance sampling in a traditional system.

FIG. 3 is a block diagram providing a visualization of the relative amount of bad claims and tagged claims against total claims and quality assurance sampling based on the present disclosure.

Similar reference characters refer to similar parts throughout the several views of the drawings.

### DETAILED DESCRIPTION OF THE PREFERRED EMBODIMENT

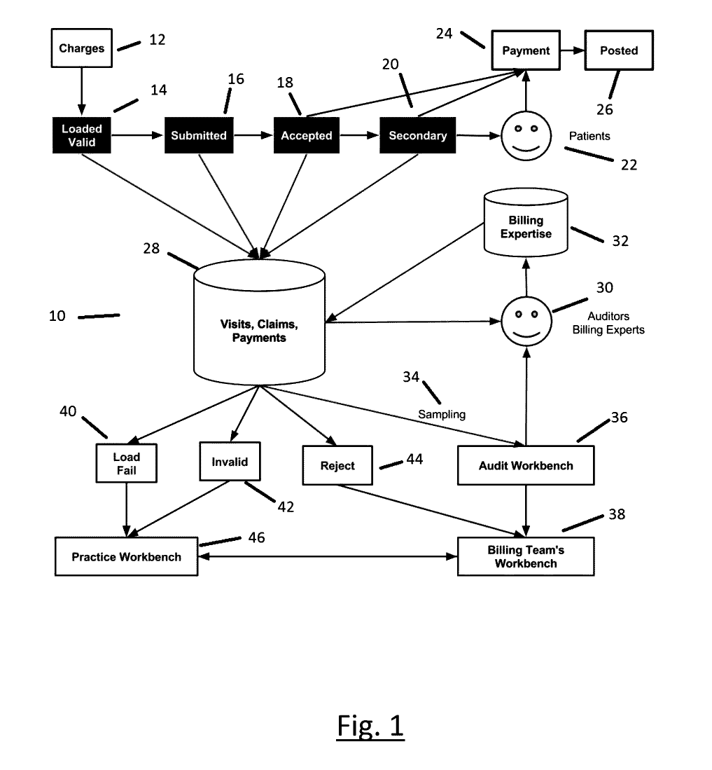

A quality assurance injection method and system 10 is shown in the flowchart of FIG. 1. The preferred method of the present invention begins with the input of “true” insurance claims 12 into a pre-programmed computer system with a rules database 28. True insurance claims 12 are defined as actual charges incurred for the use of a professional's services to be paid by the patient or their insurance carrier. For example, a patient visiting a doctor will incur a true insurance claim 12 for the services provided by said doctor, whether that is a routine checkup or some other more advanced service. After the true insurance claims 12 are loaded into the quality assurance injection method and system 10, the quality assurance injection method and system 10 makes several determinations. The quality assurance injection method and system 10 is a specialized database pre-programmed to evaluate claims in order to send them to the proper staff and to evaluate the claims themselves. First, it makes a valid loading determination 14 as to whether the charge was loaded correctly and is a valid charge by sending the true insurance claim 12 to the pre-programmed computer system with a rules database 28. If the charge is loaded correctly and states a valid charge, a submission determination 16 is made deciding whether the charge is going to be submitted using the pre-programmed computer system with a rules database 28. If the true insurance claim 12 will be submitted, an acceptance determination 18 decides whether the true insurance claim 12 will be accepted by whoever receives the bill. If the true insurance claim 12 will be accepted, any secondary characteristic determination 20 is then made using the pre-programmed computer system with a rules database 28. Once the secondary characteristic determination 20 is made, a payment determination 24 is made as well as a posting determination 26. This process determines the status of the true insurance claim 12 as valid or invalid.

The pre-programmed computer system with a rules database 28 has rules for valid loading determination 14, submission determination 16, acceptance determination 18, and secondary characteristic determination 20. The pre-programmed computer system with a rules database 28 also has rules for a load fail determination 40, invalidity determination 42, and rejection determination 44. Should the pre-programmed computer system with a rules database 28 determine that the true charge 12 was improperly loaded 40 or invalid 42, the true charge 12 is sent to a practice workbench 46 where the quality assurance staff 30 are informed as to the true charge's 12 deficiency. If the true charge 12 is determined to be rejected 44, the true charge will be sent to the billing team's workbench 38 for the quality assurance staff 30 to work out the issue with the insurance carrier.

The preferred embodiment of the quality assurance injection method and system 10 has a known sample 34 of tagged claims 56 (as shown in FIG. 3) injected into the pre-programmed computer system with a rules database 28 and sent to an audit workbench 36 for staging. The tagged claims 56 are intentionally defective. The defect is generally based on one of the status determinations including the valid loading determination 14, submission determination 16, acceptance determination 18, and secondary characteristic determination 20. The pre-programmed computer system with a rules database 28 recognizes the tagged claims 56 as defective when injecting them into the system. This injection can occur randomly or at preset times. The sample 34 is then sent to the quality assurance staff 30.

The quality assurance staff 30 perform their normal duties, hopefully catching the tagged claims 56 and marking them as false. Inevitably, a few tagged claims 56 will slip by the quality assurance staff 30. The overall performance by the quality assurance staff 30 is then captured for analysis. The tagged claims 56 that were caught by quality assurance staff 30, as well as those not caught by quality assurance staff 30, are sent to a billing expertise data center 32. The billing expertise data center 32 then analyzes the tagged claims 56 that were caught and compares them to the tagged claims 56 that were not caught. The billing expertise data center 32 then sends its analysis to the pre-programmed computer system with a rules database 28 for future generation of tagged claims 56 and for future assessment of quality assurance staff 30.

Several types of tagged claims 56 can be created. A “template” can be defined for the purposes of this description as a crafted medical insurance claim. The templates created by the administrator or through the use or previously flagged invalid claims feature missing information crucial to making a true claim 12 valid. This makes the tagged claims 56 defective and able to be recognized by the pre-programmed computer system with a rules database 28. These templates are fed into the pre-programmed computer system with a rules database 28 which are then replicated and sent out to quality assurance staff 30.

The injection of tagged claims 56 can be handled in several different ways. An administrator can determine when to input tagged claims 56 into the pre-programmed computer system with a rules database 28 or they can manually input tagged claims 56. Alternatively, the pre-programmed computer system with a rules database 28 can generate tagged claims 56 and include the tagged claims 56 in the sample 34 sent to the quality assurance staff 30.

Creating a set of realistically looking tagged claims 34 is challenging. The present invention uses an approach using three methods: (1) limiting the view the quality assurance staff 30 receives to only select aspects of the sampled claim; (2) reusing previously flagged bad claims 52; and (3) building a database of fake control claims by reusing earlier flagged bad claims 52. These methods can be used in concert or individually. The use of these methods drastically improves the functioning of the method and system because the method and system would not work in the quality assurance staff 30 knew which claims were defective and which were not. It is impossible to assess performance when the party to be tested has knowledge of the test beforehand.

When the tagged claims 56 reach the audit workbench 36, they are sent to both the billing team workbench 38 and the quality assurance staff 30. There are several methods that can be used to determine the duration of the quality assurance period as the quality assurance staff 30 make their decisions regarding the true claims 12 and tagged claims 56. One method is to limit the amount of time tagged claims 56 are introduced into the process. For example, tagged claims 56 can be injected into the pre-programmed computer system with a rules database 28 over a 24 hour period. Once the time period is over, an administrator can count the number of missed tagged claims 34 and assess the quality assurance staff 30. The tagged claims 34 will also be used to improve the pre-programmed computer system with a rules database 28.

The verification of the analysis performed by the quality assurance staff 30 is vital to the described method and system. It is important for medical offices to employ staff who understand insurance billing because a missed claim can lead to hours of extra work haggling or arguing with the insurance company that could be used to process other claims.

Further efficiency can be achieved through the use of multiple quality assurance staff 30 teams. As an example, generating two equally random samples of one hundred claims and giving them to two teams of quality assurance staff 30 would help determine which team was better at finding bad claims. The administrator would then choose the team that was better at finding bad claims for projects requiring a more efficient team. It is important for each team to receive similar sample groups in order to adequately appraise each team's ability. Using multiple teams in combination with the rules-based system provides for a more accurate system and will provide better quality assurance. Using multiple teams also allows for administrators to establish relationships with certain quality assurance teams, establishing trust and creating a more efficient system overall.

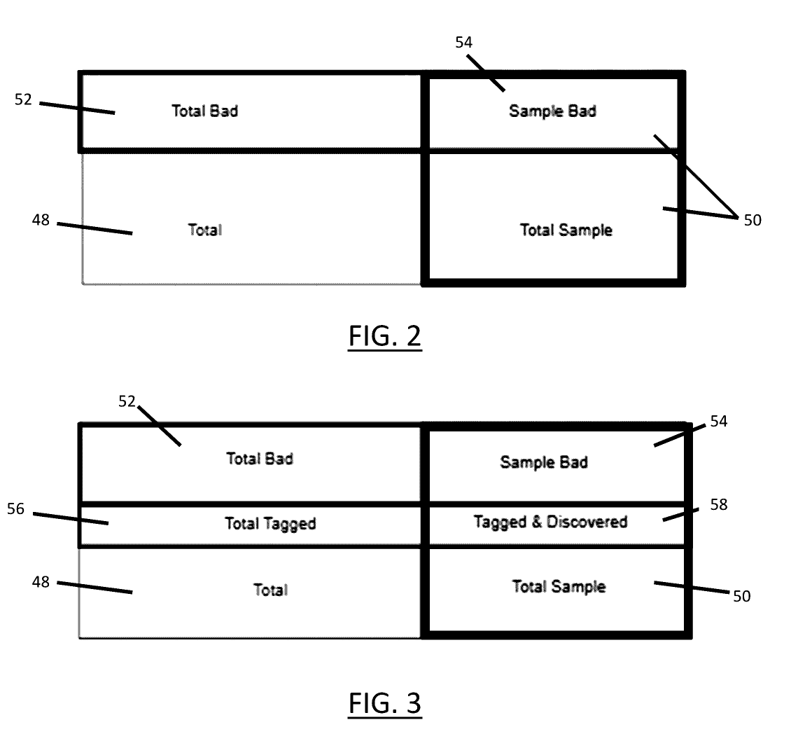

FIG. 2 shows a block diagram of a traditional quality assurance system. In the traditional system, the total claims 48 are broken up into sample claims 50 for quality assurance staff 30. An unknown number of the total claims 48 will be bad claims 52. This means a proportional amount of the sample claims 50 will contain sample bad claims 54. Based on a known number of total claims 48 and sample claims 50, a sample error rate can be calculated from the number of discovered sample bad claims 54. For example, in a system with 10,000 total claims 48 and 1,000 sample claims 50, there is a sample error rate of 20% when 200 sample bad claims 54 are discovered. This can be extrapolated to the total claims 48 to estimate that there are roughly 2,000 total bad claims 52. This can be wildly inaccurate, however, and the present disclosure is meant to increase the accuracy of the system without increasing time and effort to pinpoint a more exact number through brute force. Assuming hand examination of claims by quality assurance staff 30 can be completed at a rate of one claim per minute, a claim system containing, for example, 10,000 claims would take roughly 167 hours to parse. A team of two would take 84 hours, or two full work weeks with four hours of overtime, to parse these claims. Many systems contain many more claims than this example. This is an unacceptable amount of time and effort to spend just to determine the total number of bad claims within a system. The present disclosure is meant to decrease this time and effort, freeing up more time for staff to examine new claims.

FIG. 3 provides a block diagram of the preferred claim sampling as described in the present disclosure. Similar to FIG. 2, the system has an amount of total claims 48 and bad claims 52. However, the difference is the introduction of tagged claims 56. The tagged claims 56 are randomly distributed throughout the system such that the sample claims 50 contain the same proportion of sample tagged claims 58 against all sample claims 50 as the total tagged claims 56 has against the total claims 48. For example, the system may inject a total of 500 tagged claims 56 into the system. A random sampling of claims is sent to quality assurance staff which, in this example, includes 100 sample tagged claims 58.

The known number of bad claims 52 can be used to extrapolate the error rate for the total claims 48. Using similar logic as described for FIG. 2, the error rate of the sample will be equal to the error rate of the total system. The equation:

(sample bad+sample tagged)/total sample=(total bad+total tagged)/total claims

can be rearranged into the following equation to allow for a better calculation the total number of bad claims 52:

Total bad claims=(((sample bad+sample tagged)*total claims)/total sample)−tagged claims

For example, in a system where 500 tagged claims 56 are injected into the system with 10,000 total claims 48 and 100 are found as sample tagged claims 58 and an additional 200 sample bad claims 54 are found in a grouping of 1,000 sample claims 50, the total number of bad claims in the system can be estimated as such: Total bad claims=(((200 sample bad+100 sample tagged)*10,000 total claims)/1,000 sample claims)−500 tagged claims=2,500 bad claims. The extrapolated error rate can then be found by dividing this discovered bad claim number by the total claims in the system. This example would result in an extrapolated error rate of 25% (2,500/10,000). Comparing this result to the result found in the older system described in FIG. 2 makes it is clear that the present description provides a more accurate error estimation.

The introduction of, for example, 500 tagged claims 56 into the overall grouping of claims means that there is at least a 5% error in total. This is true even if the original 10,000 total claims 48 had no errors at all. This means that in the sample claims 50 the quality assurance staff 30 should find at least 5 errors due to the proportional randomization of the sampling (500 tagged claims out of 10,000 total claims is proportional to 5 tagged claims out of 100 sample claims). If the quality assurance staff 30 do not find at least 5 errors, then some combination of randomization from the pre-programmed computer with a rules database 28, error injection by the pre-programmed computer with a rules database 28, or quality assurance human error is to blame. Administrators can use their expertise to more quickly and accurately determine where the problem is emanating from, the computer system or human error. It is much more likely for quality assurance human error to be at fault than for the pre-programmed computer with a rules database 28 to be at fault. Under the old system, there would be no way of knowing whether the quality assurance staff had actually caught the all of sample bad claims 54 that had been presented to them or whether they had received any bad claims in their sample at all. The present disclosure prevents that mistake by providing a known error rate such that quality assurance staff 30 will be provided with a known number of tagged claims 56. Those quality assurance staff 30 that find less sample bad claims 54 than they should will receive a bad assessment and potentially receive less desirable assignments.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A computer-implemented method for improved medical insurance claims quality assurance processing, the method comprising:
storing in a specialized evaluation database a plurality of medical insurance claims wherein the plurality of medical insurance claims comprise a status wherein the medical insurance claim is either valid or invalid;
creating tagged claims through the use of templates wherein the templates are created from previously flagged invalid claims or are constructed by an administrator and wherein the tagged claims are defective in regards to at least one quality control metric wherein the at least one quality control metric is based on valid loading, submission, acceptance, or secondary characteristic properties;
executing a sampling component wherein the sampling component selects a subset of the plurality of medical insurance claims, wherein the subset of the plurality of medical insurance claims comprises claims in a plurality of statuses;
combining the subset of the plurality of medical insurance claims with a second plurality of a set of tagged claims either randomly or at a preset time;
sending the combined subset of the plurality of medical insurance claims and the set of tagged claims to an audit workbench;
providing the combined subset of the plurality of medical insurance claims and the set of tagged claims to a plurality of quality assurance staff teams;
receiving an analysis from the quality assurance staff;
verifying the analysis of the quality assurance staff by comparing the analysis with the known set of tagged claims through the use of a billing expertise database; and
comparing the analysis performed by the quality assurance staff with previous verified analyses performed by the quality assurance staff to evaluate the quality assurance staff.

2. A computer-implemented method for improved insurance claims quality assurance processing, the method comprising:
storing in a database a plurality of insurance claims;
executing a sampling component wherein the sampling component selects a subset of the plurality of insurance claims;
combining the subset of the plurality of insurance claims with a second plurality of a set of tagged claims wherein the tagged claims are defective in regards to at least one quality control metric;
providing the combined subset of the plurality of medical claims and the set of tagged claims to quality assurance staff; and
verifying the analysis of the quality assurance staff by comparing the analysis with the known set of tagged claims.

3. The quality assurance method of claim 2 wherein the insurance and tagged claims are medical insurance claims.

4. The quality assurance method of claim 2 wherein the quality assurance staff are assessed daily.

5. The quality assurance method of claim 2 wherein the known number of tagged claims provided to the quality assurance staff is proportional to the number of true claims provided to the quality assurance staff.

6. The quality assurance method of claim 2 wherein more than one team of quality assurance staff receives a combined sample of medical insurance claims and tagged claims.

7. The quality assurance method of claim 6 wherein every quality assurance staff team receives the same number of medical insurance claims and tagged claims to determine each quality assurance staff team's accuracy and efficiency.

8. The quality assurance method of claim 2 wherein the tagged claims are generated through the use of previously flagged true claims.

9. The quality assurance method of claim 2 wherein the tagged claims are generated using a randomization program in combination with previously flagged true claims.

10. The quality assurance method of claim 2 wherein the tagged claims are generated through the use of a sample tagged charge created by an administrator which is then replicated by the pre-programmed computer system.

11. The quality assurance method of claim 2 wherein the results of the quality assurance analysis are input into the pre-programmed computer system for future analysis and to further assess quality assurance staff.

12. A quality assurance injection system comprising:
a pre-programmed computer system designed to analyze billing further comprising:
a rules database;
a billing expertise data center;
an audit database; and
a practice database;
true claims collected as accounts receivable;
tagged claims injected into the pre-programmed computer system;
quality assurance staff to examine said true and said tagged claims; and
an assessment input into said rules database based on the quality assurance staff's examination of said true and said tagged claims.

13. A quality assurance injection system of claim 12 wherein the true and tagged claims are medical insurance claims.

14. A quality assurance injection system of claim 12 wherein the pre-programmed computer system is designed to analyze insurance billing.

15. A quality assurance injection system of claim 12 wherein the insurance billing is for medical insurance.

16. A quality assurance injection system of claim 12 wherein the tagged claims are generated and input into the system by a database administrator.

17. The quality assurance method of claim 16 wherein the tagged claims are generated through the use of a sample tagged charge template created by an administrator which is then replicated by the pre-programmed computer system.

18. A quality assurance injection system of claim 12 wherein the tagged claims are generated and input into the system by the rules database.

19. A quality assurance injection system of claim 12 wherein the quality assurance staff are comprised of more than one quality assurance staff team.

20. A quality assurance injection system of claim 19 wherein each quality assurance staff team receives tagged claims to determine each quality assurance staff team's accuracy and efficiency.
